(19) United States
(12) Patent Application Publication
(10) Pub. No.: US 2011/0279353 A1
(43) Pub. Date: Nov. 17, 2011

(54) APPARATUS AND METHOD FOR ENERGY DISPLAY

(75) Inventors: Dong Min SON, Suwon (KR); Jae Seong Park, Daejeon (KR); Jung Hwan Oh, Seoul (KR)

(73) Assignee: LSIS CO., LTD.

(21) Appl. No.: 13/089,131

(22) Filed: Apr. 18, 2011

(30) Foreign Application Priority Data
May 11, 2010 (KR) 10-2010-0044074

(51) Int. Cl. G09G 5/00

(52) U.S. Cl. 345/2.3; 345/2.1

(57) ABSTRACT

Disclosed herein is an energy display apparatus disposed on each energy consuming site, displaying the energy price information that is transmitted by a central server according to time zone in association with energy price fluctuating system. If a situation occurs that energy price information is not received from the central server via a first communication network, attempt is made to deliver the energy price information via a second communication network.

### CROSS-REFERENCE TO RELATED APPLICATIONS

Pursuant to 35 U.S.C. §119(a), this application claims the benefit of earlier filing date and right of priority to Korean Patent Application No. 10-2010-0044074, filed on May 11, 2010, the contents of which are hereby incorporated by reference in their entirety

### FIELD OF THE INVENTION

The present invention relates to an energy display apparatus and a method thereof, and more particularly, to an energy display apparatus and a method thereof capable of appropriately dealing with a case where energy price information is not normally received due to communication impediment under an alternating charge system in which prices of each energy such as electricity, gas, and city water fluctuates at any time.

### BACKGROUND OF THE ART

Until now, energy such as electricity, gas and city water has been provided based on maximum demand, and energy price also maintained at a fixed level.

As a measure for more efficiently using energy resources with decreasing energy consumption, a method is recently considered for differentiating energy price based on time zone or season.

One example related thereto is a smart grid, which is a next-generation power-network capable of attaching Information Technology (IT) to a power network to allow a power provider and a consumer to exchange real-time information bilaterally, thereby optimizing energy efficiency and creating new added value.

In view of energy consumers, they can use energy by searching for the most rational time zone based on fluctuations of energy price by smart grid.

Smart meter along with the smart grid refers to a digital power meter added with communication functions, and enables a real-time inspection of a total power use or bidirectional communication between a power provider and a consumer, whereby remote and real-time inspections can be realized. That is, a meter man needs no direct visit to household, and a power use amount can be accurately measured to generate effects of reducing metering cost and energy.

Due to the fact that energy use information of consumers can be provided through communication network such as Internet, they can check their energy use information any time and any where using various communication means such as web, portable phone and TV set.

Together with energy related technologies such as smart grid and smart meter, when an alternating charge system is implemented in which energy price fluctuates depending on a specific time zone, each of the consumers must be allowed to check frequently charging energy prices.

However, smooth offer of energy price information may not be materialized in some cases due to impediment of communication networks transmitting/receiving energy cost information.

Therefore, there is needed a measure to adequately address such situations, whereby provision of energy price information can be continuously maintained without any interruption.

### SPECIFIED DESCRIPTION OF THE INVENTION

### Technical Objective

The present invention is provided to cater to the above-mentioned necessities, and it is an object of the present invention to display energy price information that is frequently changing depending on a time zone under alternating price system, and to make distribution of energy price information more smoothly performed by attempting a transfer of anther path if an obstacle occurs on communication network delivering the energy price information.

### Technical Solution

An energy display apparatus according to the present invention comprises a detection means for detecting communication state with a central server; a first display means for displaying energy price information by receiving the information from the central server via a first communication network if the communication state is normal; and a second display means for displaying energy price information by receiving the information from the central server via a second communication network if the communication state is abnormal.

An energy display method according to the present invention comprises step of detecting communication state with a central server; step of displaying energy price information by receiving the information from the central server via a first communication network if the communication state is normal; and step of displaying energy price information by receiving the information from the central server via a second communication network if the communication state is abnormal.

### Advantageous Effect

An energy display apparatus according to the present invention is to basically display received energy price information from a central server that fluctuates according to time zone.

If there occurs a situation where energy price information is not effectively received, reception possibility of energy price information is enhanced by receiving energy cost information through another communication network.

As another method, when an impediment occurs on an original communication network delivering energy price information, energy price information can be provided via communication network connected to a portable terminal of a user, or an address of internet website providing energy price information is provided so that the user can easily check energy price information at a corresponding website.

As such, if an impediment occurs in any communication network delivering energy price information under the altering energy price system, energy price information may be continuously and effectively provided by attempting to transfer the information via other channels.

Therefore, the energy display apparatus and method according to the present invention can be helpful in decision making related to energy use by a user, and minimizing inconveniences of the user.

### BRIEF DESCRIPTION OF THE DRAWINGS

FIG. 1 is one example of a system providing energy price information;

FIG. 2 is an example illustrating the construction of a central server;

FIG. 3 is an energy display apparatus according to a first embodiment of the present invention;

FIG. 4 is an example of a display screen displaying energy prices;

FIG. 5 is an example where a first display means and a second display means are integrated in the first embodiment of an energy displaying apparatus according to the present invention;

FIG. 6 is an example where the first display means and the second display means are independently configured in the first embodiment of an energy displaying apparatus according to the present invention;

FIG. 7 is a conceptual view where energy price information is transmitted to a home terminal and a portable terminal;

FIG. 8 is an energy display apparatus according to a second embodiment of the present invention;

FIG. 9 is an example illustrating an operating procedure of a central server;

FIG. 10 is an example where a first communication network is assigned as communication network connecting a meter to a central server;

FIG. 11 is an example of switching an energy supply source according to communication state with a central server;

FIG. 12 is an example of a system for describing an energy display method according to a first embodiment of the present invention;

FIG. 13 is a flow chart illustrating an energy display method according to the first embodiment of the present invention;

FIG. 14 is an example of a system for describing an energy display method according to a second embodiment of the present invention; and

FIG. 15 is a flow chart illustrating an energy display method according to the second embodiment of the present invention.

### BEST MODE

Hereinafter, preferred embodiments according to the present invention will be described in detail with reference to the annexed drawings.

Energy, relating to the present disclosure, refers to any one of electricity, gas, and city water course, unless otherwise mentioned.

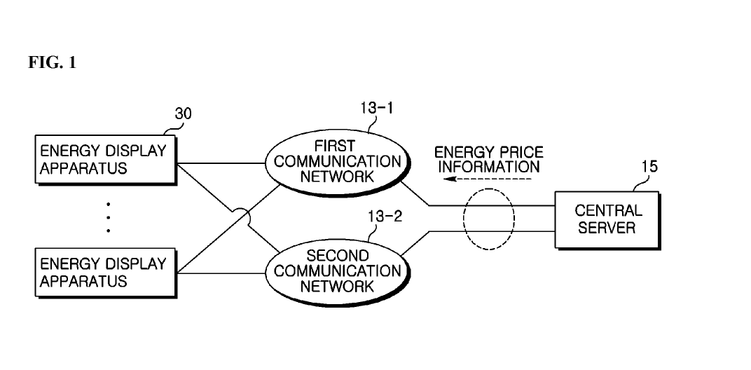

FIG. 1 diagrammatically shows a system related to a first embodiment of an energy display apparatus according to the present invention, in which an energy display apparatus 30 acquires and displays energy price information frequently fluctuating according to a time-zone from a central server 15 through a first communication network 13-1 and communication network 13-2.

The first communication network 13-1 and the second communication network 13-2 into which a central server 15 makes a transfer of energy price information may include various kinds of communication networks.

For example, the first communication network 13-1 includes a wireless mesh or a power-line communication network, and the second communication network 13-2, e.g., includes a wireless public communication network or an internet network.

The central server 15 is basically a server operated by an energy provider or a business person entitled to provide energy price information to each user.

A role performed by the central server 15 may be variously made up, and energy price information fluctuating basically according to time-zone is transmitted through the first communication network 13-1 and the second communication network 13-2 so that users can confirm the one.

The central server 15 is constructed using a computer system capable of providing energy price information via the first communication network 13-1 and the second communication network 13-2, wherein the structure and capacity, and formation may be variously constructed as needed.

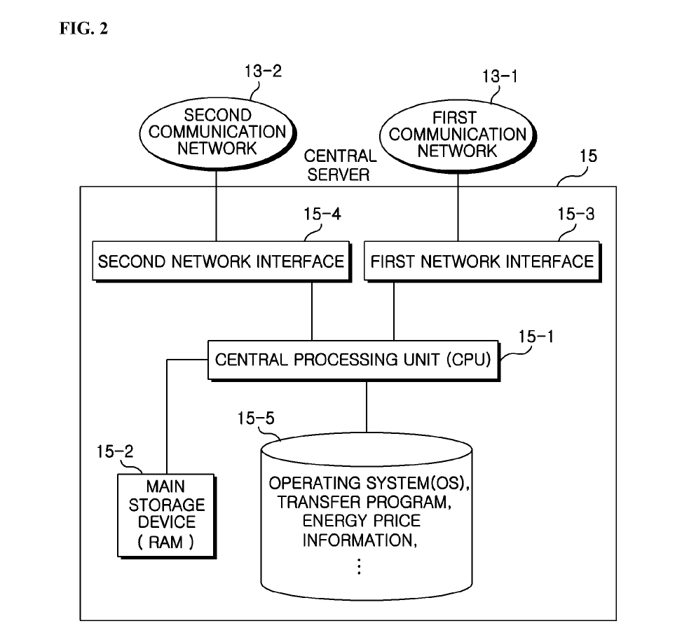

FIG. 2 shows an example of composing the central server 15, including a central processing unit 15-1 responsible for overall control of the central server 15, an RAM (Random Access Memory) as a main memory 15-2, a first network interface 15-3 and a second network interface 15-4 allowing each possible connection and communication to the first communication network 13-1 and the second communication network 13-2, and a storage media 15-5.

The storage media 15-5 has a feature of non-volatility capable of reading and writing digital data, for which an internal-type HDD (Hard Disk Drive) may be used, but not limited to this, it can have various forms containing embedded type, external type, separated type, and non-separated type.

The storage media 15-5 stores OS (Operation System) and each kind computer program and data, in which particularly, a transport program transporting energy price information via the first communication network 13-1 and the second communication network 13-2 based on energy price information fluctuating according to time-zone and transport time is installed.

The transport program stored in the storage media 15-5 becomes stored in the main memory 15-2 by the central processing unit 15-1.

And, through running the transport program stored in the main memory 15-2, the central processing unit 15-1 transports energy price information set to a transport time through the first network interface 15-3 and the second network interface 15-4 towards each of the first communication network 13-1 and the second communication network 13-2.

Energy price offered by the central server 15 may be set based on diversified criterion such as time, day of the week, and season. In transmitting energy price information, time may be variously configured, when necessary, for example periodically transmitted.

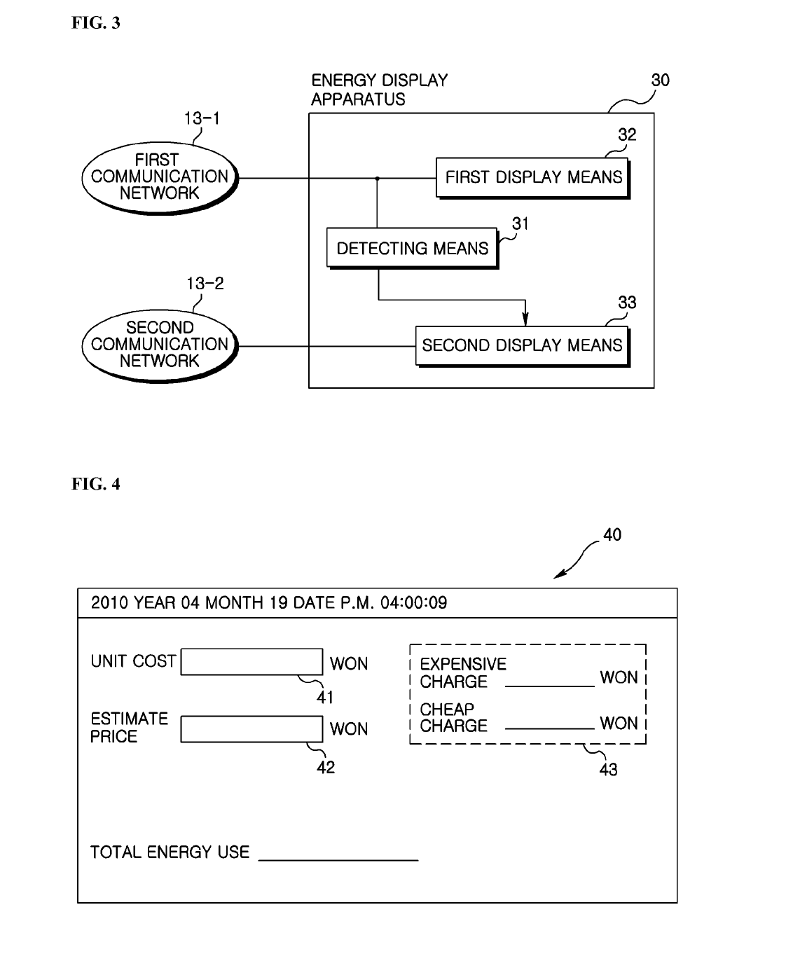

With the description of a first embodiment of an energy display apparatus according to the present invention, by reference to FIG. 3, an energy display apparatus 30 contains a detection means 31, a first display means 32, and a second display means 33.

The first display means 32 displays energy price information, communicatively received from the central server 15 via the first communication network 13-1.

The detection means 31 detects if communication of the central server 15 and the first display means 32 are in normal state.

A method of detecting communication state of the central server 15 and the first display means 32 by the detection means 31 may be variously configured. In one example, when the central server 15 periodically transmits energy price information, by confirming energy price information is received from the central server 15 via the first communication network 13-1 at a corresponding period, it can be known that communication state of the central server 15 and the first display means 32 is normal.

As a detecting result of the detection means 31, when an energy price information bound for the first display means 32 is not received because communication state of the central server 15 and the first display means 32 is abnormal, the second display means 33 receives and displays energy price information from the central server 15 through the second communication network 13-2.

FIG. 4 is an example of a screen 40 displaying of energy price information, in which energy price received from the central server 15 by the first display means 32 or the second display means 33 is marked on a unit cost column 41.

FIG. 4 is provided to help understand descriptions, thus can be variously configured however multifarious it may be the form or needs of the first display means 32 and the second display means 33.

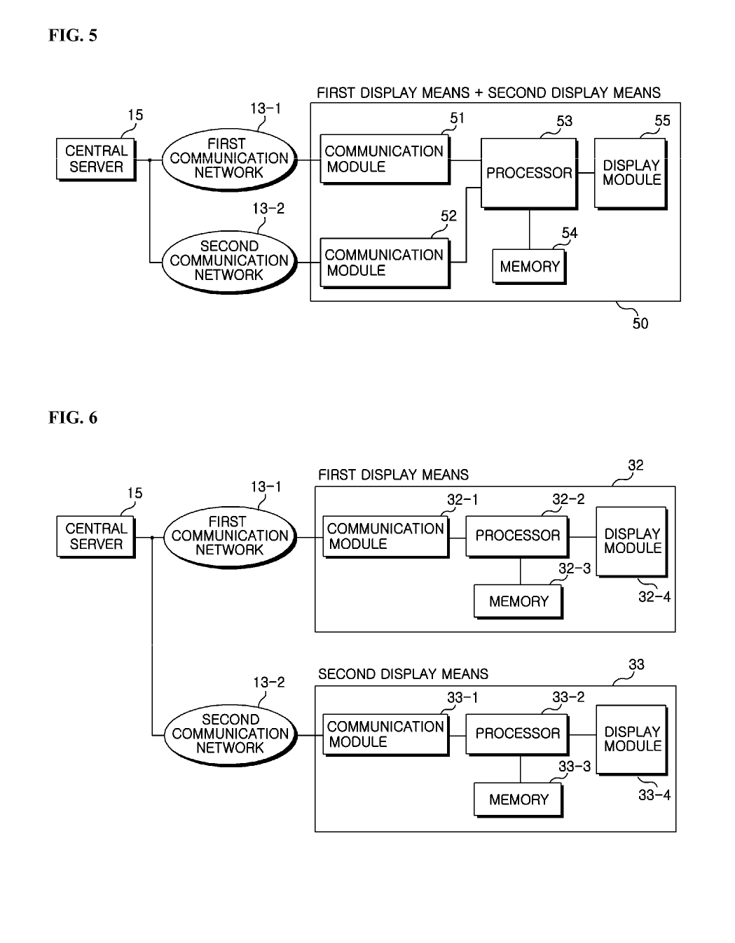

Referring to FIGS. 5 through 7, various examples related to an energy display apparatus 30 of the first embodiment according to the present invention will be explained.

FIG. 5 is a layout of an apparatus 50 integrally including the first display means 32 and the second display means 33, in which contains communication module 51 communicating via the first communication network 13-1, another communication module 52 communicating via the second communication network 13-2, a processor 53 such as central processing unit or micro processor, a memory 54 storing drive program and each kind of data, and display module 55.

The processor 53 executes the drive program stored in the memory 54, downloads energy price information from the central server 15, and displays it on the display module 55.

Specifically, the processor 53 detects if communication state of the central server 15 via the first communication network 13-1 is normal, receives energy price information from the first communication network 13-1 through the communication module 51 if the communication state is normal as a detection result, and displays it on the display module 55.

However, when communication state of the central server 15 via the first communication network 13-1 is abnormal, the processor 53 receives energy price information from the second communication network 13-2 via another communication module 52 and then displays it on the display module 55.

FIG. 6 shows an example in which the first display means 32 and the second display means 33 are individually separate apparatuses.

Each of the first display means 32 and the second display means 33 includes communication modules 32-1 and 33-1, processors 32-2 and 33-2 such as central processing unit or micro processor, memories 32-3 and 33-3 storing drive program and each kind data, and display modules 32-4, 33-4.

At this time, the communication module 32-1 of the first display means 32 is linked to the first communication network 13-1, and the communication module 33-1 of the second display means 33 is linked to the second communication network 13-2.

When communication of the central server 15 via the first communication network 13-1 is in normal state, the processor 32-2 of the first display means 32 receives energy price information from the first communication network 13-1 via the communication module 32-1, and displays it on the display module 32-4.

However, when communication state of the central server 15 through the first communication network 13-1 is abnormal, the second display means 33 receives energy price information from the second communication network 13-2 via the communication module 33-1 and displays it on the display module 33-4.

A role of the detection means 31 can be possibly performed by a corresponding device 50 in a case the first display means 32 and the second display means 33 are collectively configured like as the example of FIG. 5.

As the example of FIG. 6, in case of an apparatus where the first display means 32 and the second display means 33 are individually placed, all of the first display means 32 and the second display means 33 are performed or any one of them may be performed.

Also, the detection means 31 may be constructed in a separate device, thus functionally detecting communication state of the central server 15 via the first communication network 13-1.

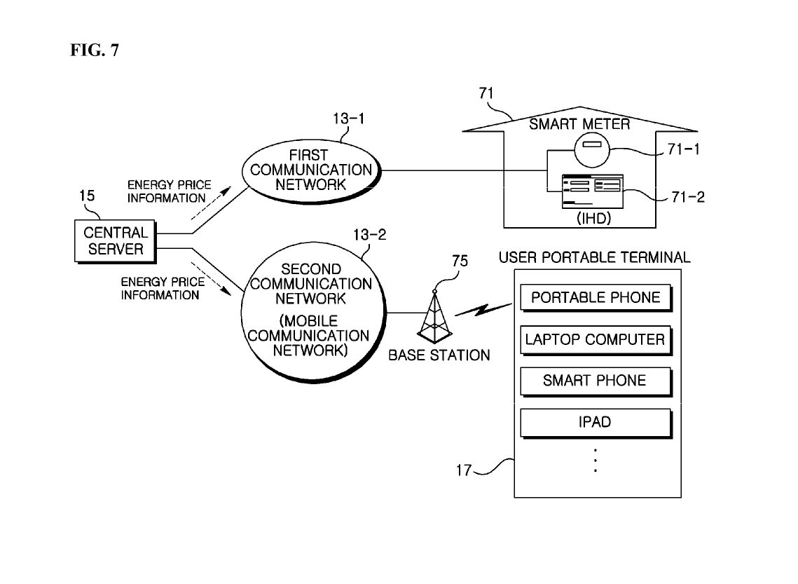

FIG. 7 shows an apparatus that the first display means 32 is placed in an energy consumption spot 71 such as a smart meter 71-1 or IHD (71-2: In Home Display), in which the second display means 33, for example, is a portable terminal 17 of a user.

Energy price information is received and displayed on the smart meter 71-1 or IHD 71-2 via the first communication network 13-1, and when communication state on the first communication network 13-1 is abnormal, received down and displayed on a portable terminal 17 of the user via a base station 75 of mobile telecommunication network acting as the second communication network 13-2. The portable terminal 17 of the user may be various kinds of mobile terminals, e.g., a portable phone, a laptop computer, a smart phone, and iPAD.

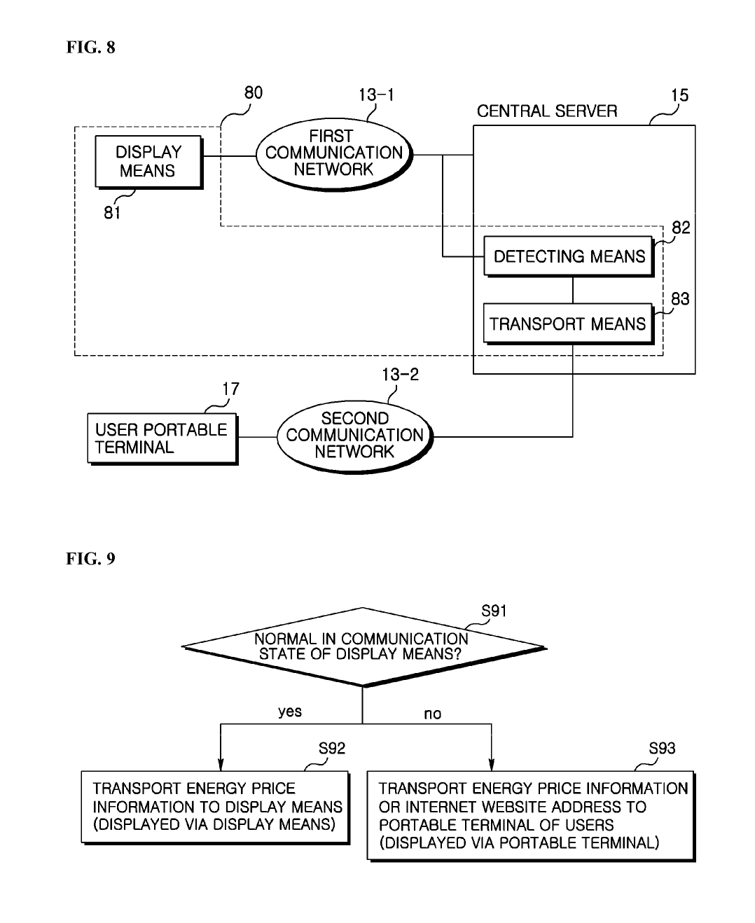

In addition, a second embodiment of an energy display apparatus according to the present invention will be explained by reference to FIG. 8. A display means 81 in the energy display apparatus 80 of the second embodiment according to the present invention is positioned in an energy dissipation spot such as home, office, company, and the role of a detection means 82 and the transport means 83 is performed in the central server 15.

The display means 81 receives and displays energy price information occasionally fluctuating according to time-zone from the central server 15 via the first communication network 13-1.

The feature of the display means 81 may be performed by the various equipment furnished in the energy consuming site. For example, a smart meter or IHD (In Home Display) may be provided, and in this case, energy price information received from the central server 15 may be displayed on the screen of the smart meter or the screen of IHD resultantly that a user can check.

The detection means 82 detects communication state between the central server 15 and the display means 81, and when as detection result of the detection means 82, communication state between the central server 15 and the display means 81 is abnormal, the transport means 83 transports energy price information or internet website address possibly telling energy price information to the portable terminal 17 of the user via the second communication network 13-2.

Energy price information transmitted via the second communication network 13-2 by the transport means 83 is the same as transported on the first communication network 13-1.

With reference to FIG. 9, an operation procedure of the detection means 82 and the transport means 83 of the central server 15 will be explained.

As a sensing result of the detection means 82, when communication state between the central server 15 and the display means 81 is normal (S91), the central server 15 transports energy price information via the first communication network 13-1, and the display means 81 receives and displays energy price information via the first communication network 13-1 (S92).

However, in the detection result of the detection means 82, if communication state between the central server 15 and the display means 81 is abnormal (S91), the transport means 83 transmits energy price information or internet website address where energy price information is posted to the portable terminal 17 of the user via the second communication network 13-2 (S93).

Herein, internet website is where energy price information is offered via internet homepages on the web.

That is, while energy price information is not displayed on the display means 81, which is caused by an impediment of the first communication network 13-1, the user can know energy price through the portable terminal 17, and confirm energy price information by connecting to a corresponding internet website.

The portable terminals 17 of the user to which the transport means 83 transports price information or internet website address may be diversified in the type and form such as portable phones, laptop computers, smart phones and iPADs.

The transport means 83 may transport corresponding information in the form of short-text message or multi-media message by interfacing to the mobile telecommunication network.

The transport means 83 possibly transports energy price information or internet website address telling energy price information to portable terminals 17 of the user as well as communication-possible various devices.

For instance, the transport means 83 may transmit energy price information or internet website address to IHD (In Home Display) placed in the energy consuming site and gaudily displaying various information.

The transport means 83 may also transmit message informing that energy price information fails to be received. Such message may be transmitted with energy price information or internet website address, or otherwise separately transmitted.

In addition, the first communication network 13-1 is communication network for supplying energy price information for the energy dissipation site, in a respect, seriously related to basic energy-relevant services.

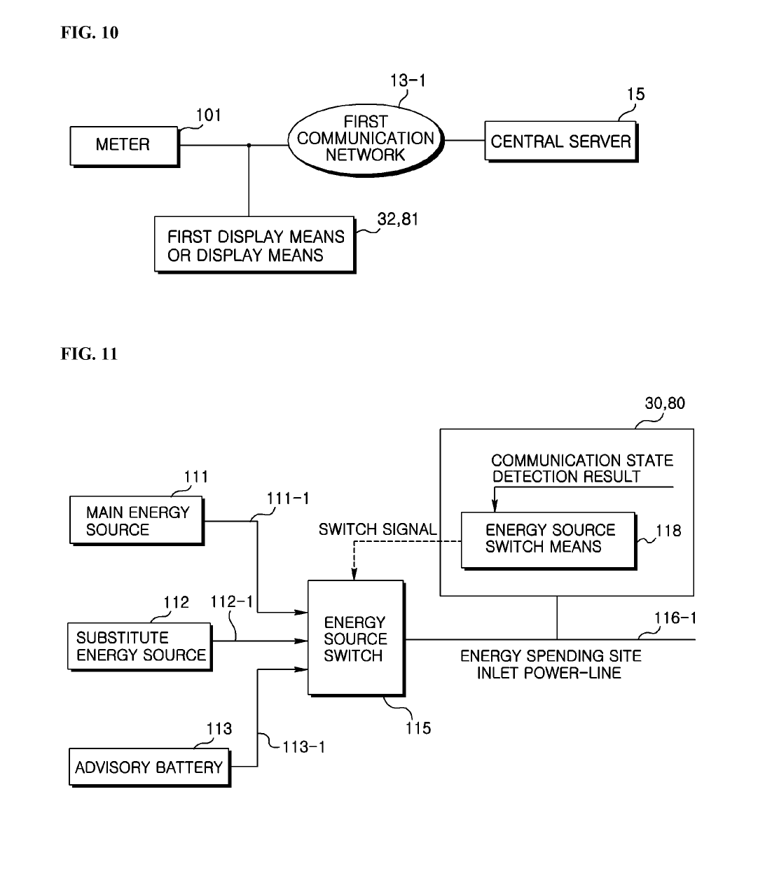

Therefore, as an example shown in FIG. 10, the first communication network 13-1 includes a communication network where a meter 101 positioned at the energy consuming site to detect energy, and the central server 15 are mutually communicated.

The meter 101 may be variously configured according to various kinds of causes such as the function, design, the type of energy, and in particular, include smart meter.

At this time, the first display means 32 of the first embodiment or the display means 81 of the second embodiment is connected to communication network where a meter 101 and the central server 15 communicate over.

Also, the first display means 32 and the second display means 33 of the first embodiment, and the display means 81 of the second embodiment may indicate an error message or a space (blank) message like ‘communication impediment’ instead of energy price information and inform the user of communication impediment state in case energy price information is not received from the central server 15.

The central server 15 may transmit current energy price information as well as each kind of additional information, which include upper-limit information and lower-limit information of energy price.

In this case, the first display means 32 and the second display means 33 of the first embodiment, and the display means 81 of the second embodiment may display energy price information together with upper-limit information and lower-limit information of energy price received from the central server 15.

In the example shown in FIG. 4, upper-limit value information and lower-limit value information of energy price may be indicated on ‘expensive charge’ and ‘cheap charge’ columns 43.

Also, the first display means 32 and the second display means 33 of the first embodiment, and the display means 81 of the second embodiment select the expensive one as the upper-limit value among previously received energy price information from the central server 15, and select the cheapest one as the lower-limit value, therefore capable of determining upper-limit value and lower-limit value of energy price without aid.

Also, the first display means 32 and the second display means 33 of the first embodiment, and the display means 81 of the second embodiment may expect and display energy estimate price based on previously received energy price information to help decision-making relating to energy use of the user in case energy price information is not received from the central server 15.

A method of expecting energy estimate price from previously received energy price information may be varied.

As the one example, the energy estimate price may be calculated based on energy price information of previous day or previous month.

For example, the energy estimate price can be determined from average energy price of previous day or previous month, energy price received at the same time zone of previous day, or energy price received at the same date and same time zone of previous month.

As another example, the most currently received energy price among energy price information received before communication state with the central server 15 becomes abnormal, may be selected as energy estimate price.

Referring to FIG. 11, energy display apparatuses 30 and 80 of the first embodiment and the second embodiment of energy display equipment according to the present invention may further include an energy-source switching means 118 controlling an energy-source switch 115 and switching an energy supplying source of energy consuming site into a substitute energy source 112 or an auxiliary battery 113, in case communication state with the central server 15 is abnormal.

A main energy source 111 is a power plant of a power supplying company, and the substitute energy source 112 refers to a power facility supplying power to the energy consuming site using sun-light power or wind force power, etc.

The energy-source switch 115 selectively connects any one of each power line 111-1, 112-1 and 113-1 of the main energy source 111, the substitute energy source 112, and the auxiliary battery 113 to a power line 116-1 lead in the energy consuming site under a switch signal.

In the first embodiment of the energy display apparatus, the detection means 31 delivers communication state detection result to the energy-source switching means 118, which delivers the switch signal to the energy-source switch 115 according to the communication state detection result.

In the second embodiment of the energy display apparatus, where the display means 81 is placed in the energy consuming site, it is possible to pass over communication state detection result to the energy-source switch means 118 in case the display means 81 fails to receive energy price information from the central server 15. Then, the energy-source switch means 118 delivers the switch signal to the energy-source switch 115 according to the communication state detection result.

And thus, the user resultantly use substitute energy instead of energy provided at the main energy source when energy price is uncertain.

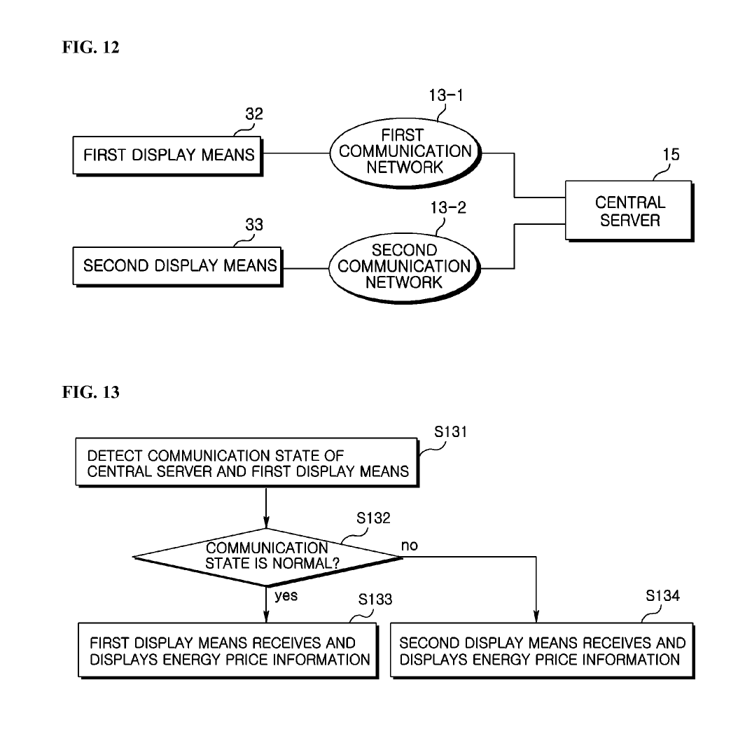

FIG. 12 shows a system for explaining the energy display method according to the first embodiment of the present invention, in which the central server 15 transmits energy price information over the first communication network 13-1 and the second communication network 13-2.

The first display means 32 receives down and displays energy price information transmitted from the central server 15 via the first communication network 13-1, and the second display means 33 receives and then displays energy price information transferred via the second communication network 13-2 from the central server 15.

Referring to FIG. 13, the energy display method according to the first embodiment of the present invention will be explained.

First, communication state between the central server 15 and the first display means 32 is detected to check that communication over the first communication network 13-1 is normally performed (S131).

The step 131 may be performed by any one of the first display means 322 or the second display means 33, or possibly performed by both of the first display means 32 and the second display means 33, and when needed, it may be performed by a third apparatus to deliver a detection result to the first display means 32 or the second display means 33.

In the step 131, a method of checking communication state between the central server 15 and the first display means 32 may be varied.

In one example, on an occasion that the central server 15 and the first display means 32 take and give energy price information periodically, it can be known by confirming that energy price information from the central server 15 is received via the first communication network 13-1 at a corresponding period.

In a sensing result of the step 131, when communication state between the central server 15 and the first display means 32 is normal (S132), the first display means 32 receives and displays energy price information via the first communication network 13-1 from the central server 15 (S133).

Alternatively, if in the sensing result of the step 131, communication state between the central server 15 and the first display means 32 is abnormal (S132), the second display means 33 receives and displays energy price information via the communication network 13-2 from the central server 15 (S134).

At this time, the first display means 32 and the second display means 33 may be constructed in an integral form inside a single apparatus as explained above referring to FIGS. 5 through 7, or constructed in a separate device.

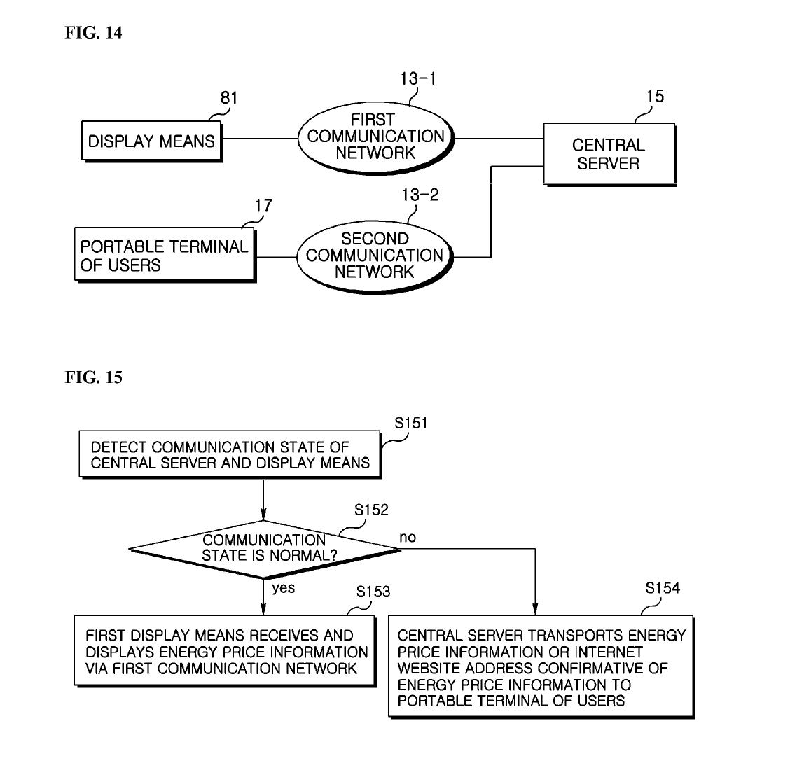

FIG. 14 shows a system for explaining the energy display method according to the second embodiment of the present invention, where the central server 15 transmits energy price information to the display means 81 placed in an energy consuming site via the first communication network 13-1. Also, the central server 15 communicates with a portable terminal 17 of the user through the second communication network 13-2.

The first communication network 13-1 and the second communication network 13-2 may be diversely configured, for example, a first communication network 13-1 may include wireless mesh or power-line communication network, and the second communication network 13-2 may include a wireless public communication network or internet network.

A role of the display means 81 receiving and displaying energy price information from the central server 15 may be performed by various appliances placed in an energy consuming site, in particular it can be possibly smart meter or IHD (In Home Display).

Referring to FIG. 15, the energy display method according to the second embodiment of the present invention will be explained.

First, the central server 15 detects if communication state with a display means 81 is normal (S151).

As a detection result in the step 151, if communication state with the display means 81 is normal (S152), the central server 15 transports energy price information over a first communication network 13-1 and in turn, the display means 81 receives and displays the same (S153).

However, as a detection result of the central server 15, if communication state with display means 81 is abnormal (S152), the central server 15 transmits energy price information or internet website address telling energy price information to a portable terminal 17 of the user via the second communication network 13-2.

Herein, the internet website includes a site where energy price information is offered via internet homepages on the web.

That is, when energy price information is not displayed on the display means 81 due to an impediment of the first communication network 13-1, the user can know energy price through the portable terminal 17, and he can check the energy price information by connecting to a corresponding internet website.

In step 154, the portable terminal 17 to which the central server 15 transports price information or internet website address includes portable phones, laptop computers, smart phones and iPADs, which transmits the corresponding information in the form of short-text message or multi-media message via the mobile telecommunication network.

Also, the information can be transmitted to communication-possible various devices such as IHD (In Home Display) placed in an energy consuming site to display each kind information.

In step 154, the transport means 83 may simultaneously transmit a message informing that the display means 81 fails to receive energy price information.

The first communication network 13-1 includes communication network supplying energy price information for energy dissipation site, which is seriously related to energy-relevant services.

Therefore, the first communication network 13-1 of the first embodiment or the second embodiment of the energy display method according to the invention includes communication network where a meter placed in the energy consuming site to detect energy and the central server 15 are mutually communicated.

Also, the first display means 32, the second display means 33 and the display means 81 of the first embodiment and the second embodiment may indicate an error message or a space (blank) message like ‘communication impediment’ instead of energy price information in case energy price information is not received from the central server 15.

The central server 15 may transmit current energy price information as well as each kind of additional information, which includes upper-limit information and lower-limit information of energy price.

In this case, the first display means 32, the second display means 33 and the display means 81 of the first embodiment and the second embodiment of the energy display method according to the invention may display upper-limit information and lower-limit information of energy price received from the central server 15.

Further, they select the most expensive one as the upper-limit value among previously received energy price information from the central server 15, select the cheapest one as the lower-limit value, and display them.

Also, the first display means 32, the second display means 33 and the display means 81 of the first embodiment and the second embodiment of the energy display method according to the invention may expect and display energy estimate price based on previously received energy price information in case energy price information is not received from the central server 15.

A method of expecting energy estimate price from previously received energy price information may be varied.

As the very one example, energy estimate price may be calculated based on energy price information of previous day or previous month. That is, energy estimate price can be selected from average energy price of previous day or previous month, energy price received at the same time zone of previous day, or energy price received at the same date and same time zone of previous month.

As another example, the most currently received energy price among energy price information received before communication state with the central server 15 becomes abnormal, may be selected as energy estimate price.

Referring to an example of FIG. 4, an expected energy estimate price can be indicated on an estimate price column 42.

The above-described embodiments are for supporting the understanding of the invention, and conscientiously, it is obvious by those skilled in the art that the present invention is not limited to the above embodiment but possibly subject to various modifications without departing from the technical scope of the disclosed particular.

1. An energy display apparatus comprising:
a detection means for detecting communication state with a central server;
a first display means for displaying energy price information by receiving the information from the central server via a first communication network if the communication state is normal; and
a second display means for displaying energy price information by receiving the information from the central server via a second communication network if the communication state is abnormal.

2. The energy display apparatus of claim 1, wherein the second display means is a portable terminal, and the apparatus further comprises a transfer means for transferring the energy price information or/and internet website address capable of knowing the energy price information to the portable terminal via the second communication network when the communication state is abnormal.

3. The energy display apparatus of claim 2, wherein the first display means is a smart meter or an IHD (In Home Display).

4. The energy display apparatus of claim 1, wherein one of or both the first and the second display means estimate an energy estimate price and display it if energy price information is not received from the central server.

5. The energy display apparatus of claim 4, wherein the estimation of the energy price information is performed based on the energy price information of a previous day or a previous month.

6. The energy display apparatus of claim 5, wherein an energy price most recently received from the central server is estimated as the energy estimate price.

7. The energy display apparatus of claim 1, wherein one of or both the first and the second display means display a blank message or an error message, if the energy price information is not received from the central server.

8. The energy display apparatus of claim 1, wherein the first and the second display means display one or more information of upper-limit value and lower-limit value of energy prices, together with energy price information.

9. The energy display apparatus of claim 3, the transfer means transmits a message informing that the energy price information is not received.

10. The energy display apparatus of claim 1, further comprising energy source switching means for switching an energy supply source of an energy consuming site to a substitute energy source or an auxiliary battery, if the communication state with the central server is abnormal.

11. The energy display apparatus of claim 2, wherein one of or both the first and the second display means estimate an energy estimate price and display it if energy price information is not received from the central server.

12. The energy display apparatus of claim 2, wherein one of or both the first and the second display means display a blank message or an error message, if the energy price information is not received from the central server.

13. An energy display method comprising:
(a) detecting communication state with a central server;
(b) displaying energy price information by receiving the information from the central server via a first communication network if the communication state is normal; and
(c) displaying energy price information by receiving the information from the central server via a second communication network if the communication state is abnormal.

14. An energy display method of claim 13, wherein the second communication network is a wireless public communication network or an internet network.

15. An energy display method of claim 14, wherein the step of (a) includes displaying the energy price information on a smart meter or an IHD.

16. An energy display method of claim 13, wherein one of or both the steps of (b) and (c) include displaying an energy estimate price by estimating the price if energy price information is not received from the central server.

17. An energy display method of claim 16, wherein the estimation of the energy price information is performed based on the energy price information of a previous day or a previous month.

18. An energy display method of claim 17, wherein an energy price most recently received from the central server is estimated as the energy estimate price.

19. An energy display method of claim 13, wherein one of or both the steps of (b) and (c) include displaying a blank message or an error message, if the energy price information is not received from the central server.

20. The energy display method of claim 13, wherein the steps of (b) and (c) include displaying one or more information of upper-limit value and lower-limit value of energy prices, together with energy price information.
